(19) United States
(12) Patent Application Publication
(10) Pub. No.: US 2026/0033636 A1
(43) Pub. Date: Feb. 5, 2026

(54) TRIM TENSION MANAGEMENT MECHANISM

(71) Applicant: LEAR CORPORATION, Southfield, MI (US)

(72) Inventor: Eric Brines, White Lake, MI (US)

(21) Appl. No.: 18/794,396

(22) Filed: Aug. 5, 2024

(51) Int. Cl. A47C 7/14; A47C 31/02; B60N 2/02; B60N 2/64; B60R 13/02; B60R 16/02

(52) U.S. Cl. CPC A47C 7/144; A47C 31/023; B60N 2/0284; B60N 2/64; B60R 13/02; B60R 16/0215

(57) ABSTRACT

An assembly includes a seat structure, trim material associated with the seat structure, and a length adjuster associated with the trim material. The length adjuster is movable between a retracted position and an extended position. A trim attachment wire has a first portion coupled to the seat structure to define a pivot axis and a second portion coupled to an edge of the trim material. The edge of the trim material moves with the second portion about the pivot axis as the length adjuster moves between the retracted position and the extended position.

### BACKGROUND

Seats may include a cushion length adjuster that is used to adjust an overall length of a seat cushion.

### BRIEF DESCRIPTION OF THE DRAWINGS

FIG. 1 is a perspective view of an example seat with a cushion length adjuster in a retracted position.

FIG. 2 is similar to FIG. 1 but shows the cushion length adjuster in an extended position.

FIG. 3A is a front view of a trim tension management mechanism.

FIG. 3B is a perspective view of the trim tension management mechanism of FIG. 3A with a clip type attachment interface.

FIG. 3C is a side view of the trim tension management mechanism of FIG. 3B.

FIG. 4 is a front view of the trim tension management mechanism of FIG. 3A as installed in a seat assembly with a carrier plate of a cushion length adjuster being removed for clarity.

FIG. 5 is a perspective view of the trim tension management mechanism of FIG. 4.

FIG. 6 is a side view of the trim tension management mechanism of FIG. 4.

FIG. 7 is a view similar to FIG. 5 but with the carrier plate included.

FIG. 8 is a side view of the trim tension management mechanism of FIG. 7.

FIG. 9 is a front view of the trim tension management mechanism of FIG. 7.

FIG. 10A is a side schematic view of a trim cover associated with the trim tension management mechanism in a retracted position.

FIG. 10B is similar to FIG. 10A but shows an extended position.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a trim tension management mechanism for a cushion length adjuster that includes a trim attachment wire attached to a seat pan and to an edge of trim material to adjust trim tension during retraction and extension of a forward portion of a seat cushion.

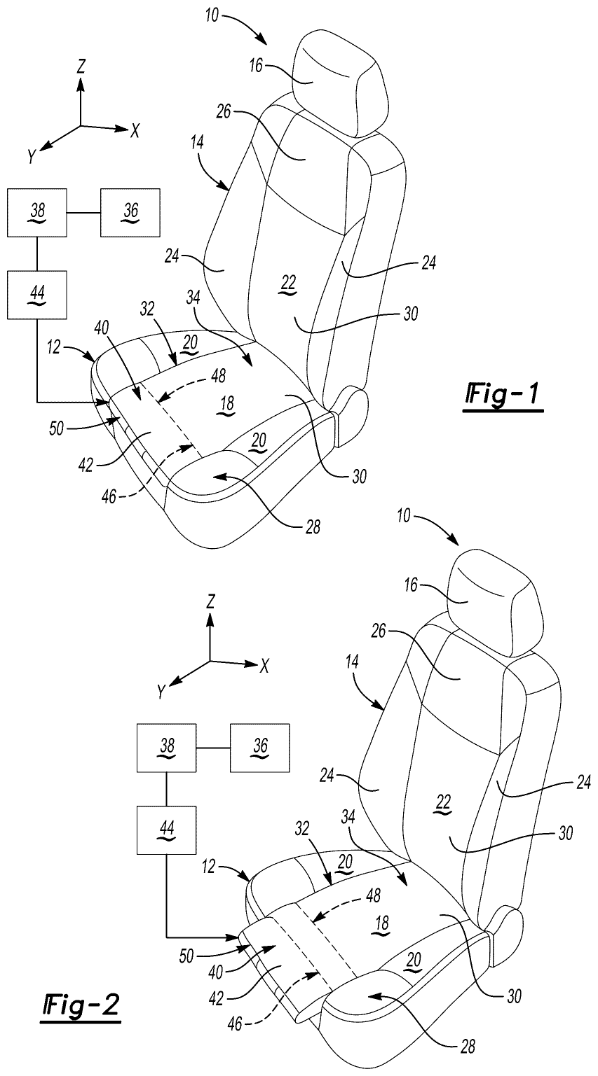

FIG. 1 illustrates a seat assembly 10 according to one example embodiment. In this example the seat assembly 10 is illustrated to be a bucket seat assembly; however, it should be understood that the subject matter of the disclosure would also be applicable to other types of seat assemblies, such as bench, captain, etc., for example. The seat assembly 10 may be utilized as a vehicle seat assembly 10 to support an occupant for seating in a vehicle, such as an automobile, an aircraft, a watercraft, or any other seating environment such as a theater, for example. The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for pivotal adjustment relative to the seat bottom 12. The seat bottom 12 may be mounted on a seat frame which can be removably secured to a vehicle floor. A head restraint 16 may also be mounted to the seat back 14.

The seat bottom 12 includes a central seating surface 18 and a seating surface along a pair of side bolster regions 20 laterally spaced about the central seating surface 18. The seat back 14 includes a pelvic/lumbar seating surface 22 with a pair of laterally spaced apart side bolster regions 24 on either side. A thoracic/shoulder seating surface 26 is provided above the pelvic/lumbar seating surface 22 and the seating surface of seat back side bolster regions 24.

In implementations, each of the seat back 14 and seat bottom 12 may include one or more foam cushions to form the seat back 14 and seat bottom 12. The foam cushion can be conventionally secured to the seat frame by any method generally known in the art. Each foam cushion may be one or more foam parts, joined together to form the seat component. For example, the seat bottom 12 foam cushion may include side bolster portions 20. The foam cushions can have any suitable size and be formed from any suitable configuration of components. The seat back foam cushion and the seat bottom foam cushion can independently comprise any suitable comfort foam material such as, but not limited to, a suitable resilient polymer, and can independently be formed in any suitable manner. For example, the foam cushions may be formed of conventional polyurethane foam, soy-based foam, silicone, thermoplastic olefins, thermoplastic urethanes, and/or natural oil-based expanded polyurethanes, soy-based polyurethane, polymer fibers, non-woven polyester pads, latex foams and the like. The foam cushions are formed of any suitable comfort material that provides soft resilience as the seat assembly is deflected during use when an occupant is in a seated position.

The seat assembly 10 also includes trim cover assembly 28 adapted to engage the foam cushions in a covering relationship for each of the seat back 14 and seat bottom 12. The trim cover assembly 28 may be secured to the foam cushions in any suitable manner, such as, but not limited to, by mechanical fasteners or heat forming. The trim cover assembly 28 includes one or more trim covers 30 (e.g., for one or more cushions of the seat component), which may comprise any material commonly known in the art. By way of example, some of the known materials include cloth, fabric, leather, synthetic leather, vinyl, synthetic suede, non-woven fabric, or combinations thereof (fabric-to-fabric, leather-to-leather, fabric-to-leather, leather-to-fabric, etc.), or polymers of sufficient quality and thickness for use in seat trim applications. Polymer trim materials may include a flexible closed cell polymer skin material such as polyvinyl, polyvinyl chloride (PVC), thermoplastic olefin (TPO), or thermoplastic urethane (TPU). Additionally, materials for use as layers of the trim cover 30 may include a foam backing (not shown, but generally known in the art) which may be manufactured from a variety of polymer foam materials. By way of example, the foam backing may be polyethylene, polypropylene, polyurethane, or a polystyrene foam. Optionally, other layers such as a mesh or reinforcing material (not shown, but generally known in the art) such as fiberglass or nylon may be applied to the foam backing or back of the trim cover 30 for increasing strength without increasing rigidity.

The trim cover assembly 28 provides an occupant seating surface for the seat back 14 and seat bottom 12. The occupant seating surface is formed on the A-side of the seat assembly 10, which is the external surface visible to the occupant. It should be understood that the cushion for the seat back 14 can differ from the cushion of the seat bottom 12. Likewise, it should be understood that the trim cover assembly 28 for the seat back 14 can differ from the trim cover assembly 28 for the seat bottom 12.

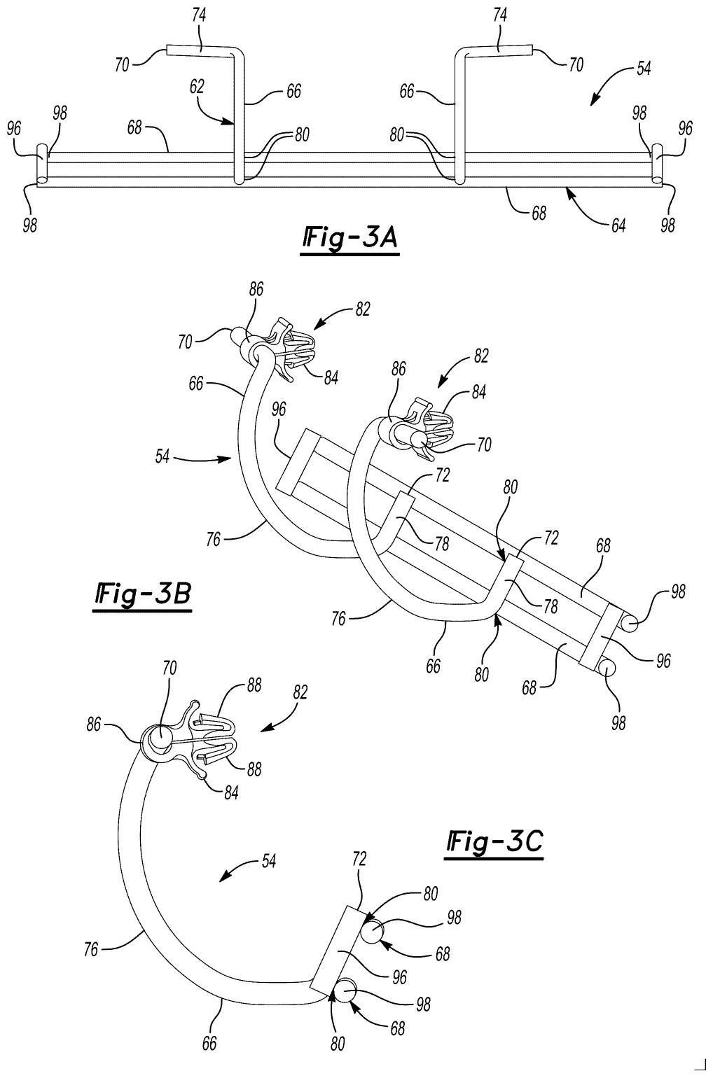

As shown in FIGS. 1 and 2, the seat bottom 12 includes a cushion defined by side bolsters 20, a center portion 32, and a rear region 34, that cooperate with the trim cover 30 to form the seating surface of the seat bottom 12. The seat bottom 12 further includes a forward region with a seat cushion length adjuster 40 to allow the occupant to move a portion of the seat cushion of the seat bottom 12 to a desired location in a Y-direction, e.g., a longitudinal direction, to adjust the length of the seat bottom 12. The seat cushion length adjuster 40 is covered by a trim portion 42 of the trim cover 30. The seat cushion length adjuster 40 has a retracted position (FIG. 1) and an extended position (FIG. 2), and as the seat cushion length adjuster 40 moves between these positions, a desired tension of the trim cover is maintained. For example, when the mechanism 40 moves forward, the trim cover 30 has to compensate for that movement as a single piece. In implementations, the seat cushion length adjuster 40 includes a trim attachment wire 54 FIG. 3A) that allows for the trim to shift with the extension/retraction of the length adjuster mechanism 40 and to always maintain the desired tension on the trim along the length of movement.

In implementations, the seat cushion length adjuster 40 is movable in the Y-direction (e.g., moveable longitudinally in forward and backward directions as defined along the Y-axis) between the retracted position and the extended position. Although FIG. 2 shows the seat cushion length adjuster 40 in a particular extended position, the seat cushion length adjuster 40 may be positioned at any suitable location along the Y-axis based on the extension desired/selected by the occupant, up to a maximum distance as predefined based on a movement mechanism for the seat cushion length adjuster 40. The seat cushion length adjuster 40 may be moved forward toward and to the extended position in any suitable manner by an actuator or movement mechanism 44, such as, but not limited to, by a motor mechanism, an electronic slide mechanism, manual engagement, or other suitable movement mechanism. Those skilled in the art who have the benefit of this description will be able to determine a suitable movement mechanism that would be applied for these purposes.

In implementations, the movement mechanism 44 may be controlled by one or more controllers 38. A user may selectively provide input via an input interface 36 to selectively control the position of the seat cushion length adjuster 40. The input interface 36 may be a button, toggle, switch or other similar device associated with the seat assembly 10, or may be an input interface associated with a dashboard screen or smart device, for example. In response to the selective input request, the controller 38 may then actuate the movement mechanism 44 to move the seat cushion length adjuster 40 to the desired selected position.

The controller 38 may include a processing unit and non-transitory memory for executing various control strategies. The processing unit can be a custom made or commercially available processor, a central processing unit (CPU), or generally any device for executing software instructions. The memory can include any one or combination of volatile memory elements and/or nonvolatile memory elements. The processing unit can be programmed to execute one or more programs stored in the memory. The programs may be stored in the memory as software code, for example. The programs stored in the memory may include one or more additional or separate programs, each of which includes an ordered list of executable instructions for implementing logical functions associated with controlling the valve bank. While shown as a single controller, the controller 38 may be comprised of one or more controllers. The controller 38 may also be in communication with, and responsive to instructions from, another controller.

When in the retracted position of FIG. 1, the seat cushion length adjuster 40 has a rear edge 46 that is flush with an edge 48 of the center portion 32. In the retracted position, the seat cushion length adjuster 40 has a forward portion 50 that is at an initial Y-axis position. When in the extended position of FIG. 2, the forward portion 50 of the seat cushion length adjuster 40 has been moved further along the Y-axis in the forward direction to the extended position, which elongates the occupant support surface of the seat bottom 12 for occupant comfort. The seat cushion length adjuster 40 is movable from the retracted position such that the rear edge 46 is moved forward and spaced apart from the edge 48 of the center portion 32. Upon movement of the seat cushion length adjuster 40, the trim cover 30 moves with the forward portion 50.

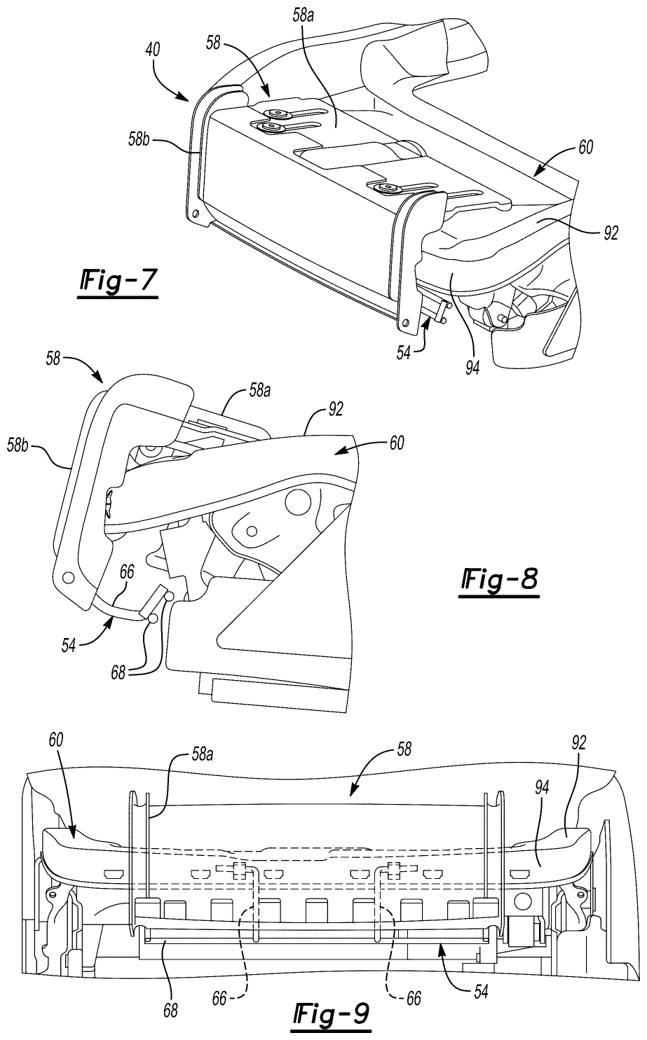

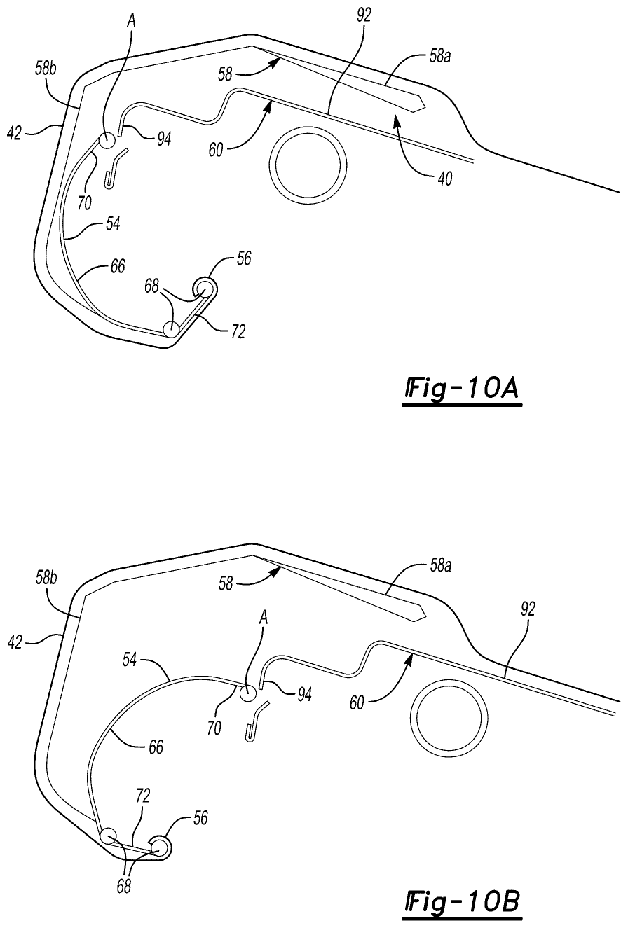

The subject disclosure provides for a trim tension management mechanism for the cushion length adjuster 40 that includes the trim attachment wire 54 (FIGS. 3A-C), which is attached to a seat structure and to an edge 56 of trim material of the adjuster trim portion 42 (FIGS. 10A-B) to adjust trim tension during retraction and extension of the forward portion 50 of a seat cushion. The trim tension management mechanism maintains a generally constant trim tension throughout a range of travel of the cushion length adjuster mechanism. In implementations, the trim attachment wire 54 attaches to a front of a cushion behind a cushion length adjuster carrier plate 58 (FIG. 7) and rotates with the cushion length adjuster 40 to relax the attaching point during extension and to pull the attaching point during retraction to maintain a near constant trim tension.

In this example the seat assembly 10 is illustrated to have cushion length adjuster with the forward portion 50 and center portion 32 as shown in FIGS. 1-2; however, it should be understood that the subject matter of the disclosure would also be applicable to other types of cushion length adjusters in various different types of seat assemblies. Thus, the cushion configuration shown in FIGS. 1-2 is just one example, and it should be understood that the trim attachment wire 54 can be used with any type of cushion length adjuster configuration.

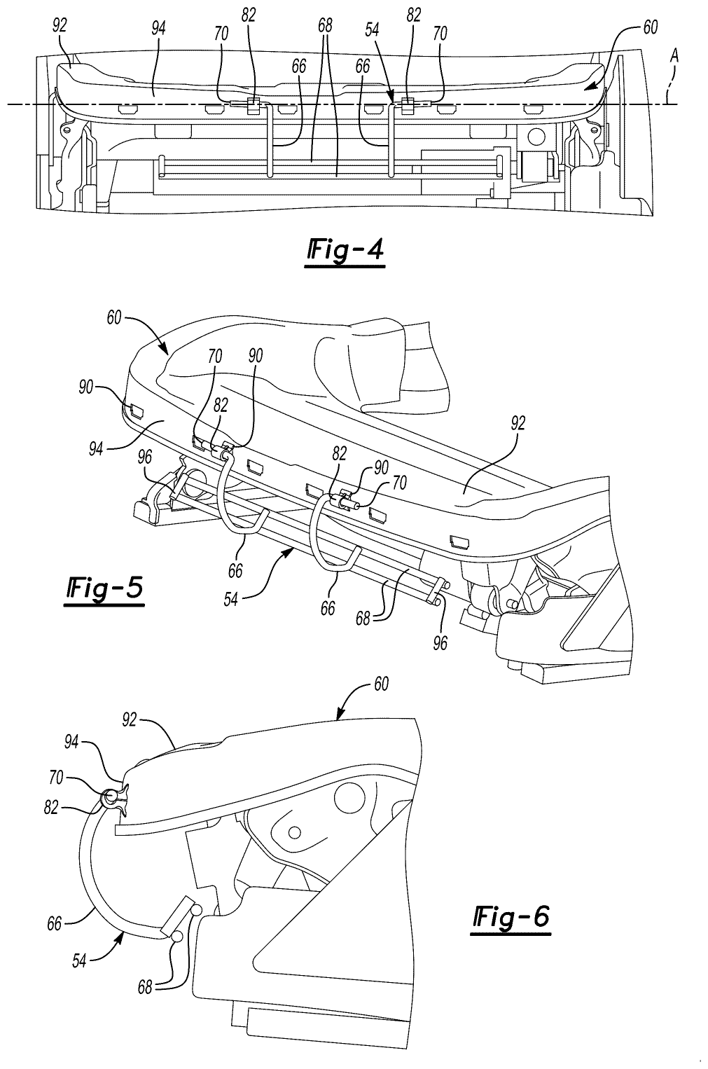

In implementations, the trim attachment wire 54 of FIGS. 3A-C is attached to a seat structure such as a seat cushion that is associated with a seat pan, seat frame, or other seat bottom component. In the example of FIG. 4, the trim attachment wire 54 is attached to a seat cushion pan 60. In implementations, the length adjuster 40 comprises a carrier plate 58 coupled to the movement mechanism 44 (e.g., a linear actuator, gear drive, linkages, or as further described above) which selectively moves the forward portion 50 of a cushion of the seat bottom 12 relative to a main body or rear region 34 of the seat cushion.

FIGS. 3A-C show one example of the trim attachment wire 54. In implementations, the trim attachment wire 54 comprises an elongated body structure having multiple attachment points and dynamic function to move with trim portion 42 to maintain near constant trim tension throughout extension and retraction of the forward portion 50 of the cushion of the seat bottom 12. In one example, the trim attachment wire 54 has a first portion 62 coupled to the seat structure, e.g. seat pan 60, to define a pivot axis A (FIG. 4) and a second portion 64 that is coupled to the edge 56 (FIGS. 10A-B) of the trim portion 42.

In implementations, the first portion 62 comprises one or more arms 66 that extend outwardly and downwardly relative to the seat pan 60.

In implementations, the second portion 64 comprises one or more bars 68 that extend along the X-axis, e.g., across a lateral width of the seat assembly 10.

In implementations, the edge 56 of the trim portion 42 comprises a lowermost edge of trim material that associated with the forward, movable portion 50 of the seat bottom 12. The edge 56 of the trim portion 42 moves with the second portion 64 about the pivot axis A as the length adjuster 40 moves between the retracted position and the extended position (see FIGS. 10A-10B).

In implementations, the trim attachment wire 54 comprises a single body including the arms 66 and bars 68 that move together as a unit. In one example, the trim attachment wire 54 is formed as a single piece and comprises a monolithic structure. In one example, the trim attachment wire 54 is formed of multiple pieces that are attached together to form a monolithic structure.

In implementations, the one or more arms 66 comprise a pair of thin wire bodies that extending in a first direction and the one or more bars comprise a pair of thin wire bodies that extend in a second direction that is transverse relative to the first direction.

In implementations, the one or more arms 66 each have a first end 70 (e.g., laterally extending distal ends) attached to the seat pan 60 to define the pivot axis A, and the arms 66 extend to a second end 72 that is associated with the one or more bars 68.

In one example, the first ends 70 of the arms 66 comprise distal ends of a linear portion 74 that extends in a lateral direction along the X-axis.

In one example, the arms 66 extend longitudinally, e.g., in a direction along the Y-axis, and extend downwardly e.g., in a direction along the Z-axis, to connect to the bars 68.

In implementations, the arms 66 have a curved portion 76 between the first end 70 and the second end 72. In one example, the arms 66 are curved in the longitudinal direction to generally form a C-shape as shown in FIG. 3C.

In implementations, the arms 66 have a straight or linear portion 78 that extends from one end of the curved portion 76 to the second end 72. In one example, the liner portion 78 includes one or more attachment points 80 to the bars 68.

In the example shown in FIGS. 3A-C, there are at least two arms 66. However, depending upon the seating configuration there may be a single arm or more than two arms.

In implementations, the one or more bars 68 comprise a pair of bars 68 that extend across a lateral width, e.g., extend in a direction along the X-axis, of the seat assembly 10. However, depending upon the seating configuration there may be a single bar or more than two bars. In one example, the bars 68 are linear members that are spaced apart from, and generally parallel to, each other.

In implementations, the bars 68 pivot together about the pivot axis A defined by the first ends 70 of the arms 66 as the forward portion 50 of the seat bottom 12 moves between retracted and extended positions.

In the example shown in FIGS. 3A-C, there are at least two attachment points 80 for each arm 66. In one example, each arm 66 has one attachment point 80 associated with each bar 68.

In one example, additional linear portions 96 may attach distal ends 98 of the bars together to further increase rigidity of the trim attachment wire 54.

As shown in FIGS. 3B-C, each arm 66 of the trim attachment wire 54 is associated with at least one clip 82. In one example, the clip 82 comprises a base 84 that is associated with the seat pan 60 and a receptacle 86 that extends outward from the base 84 to receive the arm end 70.

In one example, the base 84 comprises a snap-fit with a pair of resiliently biased legs 88 (FIG. 3C) that are compressed during insertion into an associated aperture or hole 90 (FIG. 5) in the seat pan 60. Once inserted, the legs 88 expand outwardly such that the legs 88 cannot be withdrawn or removed from the hole 90.

In implementations, the seat pan 60 has a seating surface 92 and a downwardly extending lip or flange 94 at a front edge of the seating surface 92. In one example, the clips 82 fit into the holes 90, which are formed in the downwardly extending flange 94 as shown in FIGS. 4-6.

In one example, the receptacle 86 extends outwardly from the base 84 in the longitudinal direction and comprises a tubular portion that receives the distal end 70 of the arm 66.

It should be understood that clips 82 are just one form of attachment for the arms 66 to pivotally attach to the seat pan 60. Other types of fastening attachments could also be used that allow for pivotal movement.

In implementations, the length adjuster 40 comprises a carrier plate 58 that is associated with movement mechanism 44 as discussed above. In one example, the carrier plate 58 comprises a first plate portion 58a and a second plate portion 58b as shown in FIG. 7. In one example, each plate portion 58a, 58b comprises a generally flat plate body positioned to at least partially overlap the seat pan 60.

In one example, the first plate portion 58a at least partially overlaps the seating surface 92 of the seat pan 60 and the second plate portion 58b is attached to a forward edge of the first plate portion 58a. The second plate portion 58b then extends downwardly from the first plate portion 58a and overlaps the downwardly extending front flange 94 of the seat pan 60 as shown in FIG. 8.

In implementations, the arms 66 of the trim attachment wire 54 are attached to the seat pan 60 behind the carrier plate 58 as shown in FIGS. 7-9. In one example, the bars 68 comprise an attachment point for the edge 56 of trim portion 42 that rotates in response to movement of the carrier plate 58. In implementations, the attachment point comprises a fixed location where the trim portion 42 attaches to the bars 68 such that the attachment point moves to a low tension point during extension and the attachment point moves to a high tension point during retraction.

In one example, moving to the low tension point during extension relaxes trim material tension to allow the trim portion 42 to move outwardly with the forward portion 50 of the cushion. This example is shown in FIG. 10B where the carrier plate 58 has moved outwardly relative to the seat pan 60 to the extended position.

In one example, moving to the high tension point during retraction increases/tightens trim material tension to allow the portion 42 return to the retracted position with the forward portion 50 of the cushion to maintain a constant trim material tension throughout the movement. This example is shown in FIG. 10A where the carrier plate 58 has moved inwardly relative to the seat pan 60 to the retracted position.

The subject disclosure also provides for a method of adjusting tension of trim material associated with a forward portion of a seat cushion. In implementations the method may include: coupling a first portion of a trim attachment wire to a seat structure that is associated with a seat cushion having a forward portion and a main portion; coupling a second portion of the trim attachment wire to an edge of trim material that is associated with the forward portion of the seat cushion; and pivoting the edge of the trim material with the second portion about a pivot axis defined by the first portion as the forward portion of the seat cushion moves relative to the main portion between a retracted position and an extended position.

The method may include any of the following steps in any combination. For example, the method may include mounting a carrier plate of a length adjuster to selectively move with the forward portion of the seat cushion between the retracted position and the extended position.

The method may include attaching the first portion of the trim attachment wire to the seat structure behind the carrier plate and providing the second portion of the trim attachment as an attachment point for the edge of trim material, and rotating the attachment point in response to movement of the carrier plate such that the attachment point moves to a low tension point during extension and the attachment point moves to a high tension point during retraction.

As such, the subject disclosure provides for a trim tension management mechanism that maintains close to constant trim tension throughout the range of travel of the cushion length adjuster. The subject trim attachment wire attaches to the front of the cushion behind the cushion length adjuster carrier and rotates with the cushion length adjuster to relax the attachment point during extension and pull the attachment point during retraction to maintain a generally constant trim tension. This overcomes issues with prior tension mechanisms where the trim gets either too tight and stalls the motor during cushion length adjuster extension, or becomes very loose and baggy when in the retracted position.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly comprising:
a seat structure;
trim material associated with the seat structure;
a length adjuster associated with the trim material, the length adjuster movable between a retracted position and an extended position; and
a trim attachment wire having a first portion coupled to the seat structure to define a pivot axis and a second portion coupled to an edge of the trim material, wherein the edge of the trim material moves with the second portion about the pivot axis as the length adjuster moves between the retracted position and the extended position.

2. The assembly of claim 1, wherein the length adjuster comprises a carrier plate that is moveable relative to the seat structure.

3. The assembly of claim 2, wherein the carrier plate includes a first portion that overlaps a seating surface of the seat structure and a second portion that extends downwardly from the first portion and overlaps a downwardly extending lip of the seat structure.

4. The assembly of claim 2, wherein the first portion of the trim attachment wire is attached to the seat structure behind the carrier plate and the second portion comprises an attachment point for the edge of trim material that rotates in response to movement of the carrier plate such that the attachment point moves to a low tension point during extension and the attachment point moves to a high tension point during retraction.

5. The assembly of claim 1, wherein the seat structure comprises a cushion that includes a first portion and a second portion that is moved by the length adjuster relative to the first portion between the retracted position and the extended position.

6. The assembly of claim 5, wherein the trim material extends over the first portion and the second portion.

7. The assembly of claim 5, wherein the trim attachment wire comprises a single body and the first portion comprises one or more arms and the second portion one or more bars that extend transversely relative to the one or more arms.

8. The assembly of claim 7, wherein the one or more arms each have a first end attached to the seat structure to define the pivot axis, and the one or more arms extend to a second end that is associated with the one or more bars.

9. The assembly of claim 8, wherein the one or more arms have a curved portion between the first end and the second end.

10. The assembly of claim 8, wherein the one or more bars comprise a pair of bars that extend across a lateral width of the seat structure and pivot together about the pivot axis defined by the first end of the one or more arms as the second portion of the cushion moves between retracted and extended positions.

11. The assembly of claim 1, wherein the first portion of the trim attachment wire attaches to the seat structure with at least one clip.

12. A seat assembly comprising:
a seat structure;
a seat cushion supported on the seat structure, wherein the seat cushion comprises a first cushion body and a second cushion body that is moveable relative to the first cushion body between a retracted position and an extended position;
trim material associated with the second cushion body;
a length adjuster that moves the second cushion body between the retracted position and the extended position; and
a trim attachment wire having a first portion coupled to the seat structure to define a pivot axis and a second portion coupled to a lower edge of the trim material, wherein the lower edge of the trim material moves with the second portion about the pivot axis as the second cushion body of the seat cushion moves between the retracted position and the extended position.

13. The seat assembly of claim 12, wherein the length adjuster comprises a carrier plate that is moveable relative to the seat structure, and an actuator that is associated with the carrier plate and which is selectively controlled to move the carrier plate between the retracted position and the extended position.

14. The seat assembly of claim 13, wherein the first portion of the trim attachment wire is attached to the seat structure behind the carrier plate and the second portion comprises an attachment point for the lower edge of trim material that rotates in response to movement of the carrier plate such that the attachment point moves to a low tension point during extension and the attachment point moves to a high tension point during retraction.

15. The seat assembly of claim 14, wherein the first portion of the trim attachment wire comprises one or more curved arms and the second portion of the trim attachment wire comprises one or more bars that extend transversely relative to the one or more curved arms.

16. The seat assembly of claim 15, wherein the one or more curved arms each have a first end attached to the seat structure to define the pivot axis, and the one or more curved arms curve outwardly in a longitudinal direction and extend downwardly in a vertical direction to a second end that is associated with the one or more bars.

17. The seat assembly of claim 16, wherein the one or more bars comprise a pair of bars that extend in a lateral direction across a width of the seat structure and pivot together about the pivot axis as the second cushion body moves between retracted and extended positions.

18. A method comprising:
coupling a first portion of a trim attachment wire to a seat structure that is associated with a seat cushion having a forward portion and a main portion;
coupling a second portion of the trim attachment wire to an edge of trim material that is associated with the forward portion of the seat cushion; and
pivoting the edge of the trim material with the second portion about a pivot axis defined by the first portion as the forward portion of the seat cushion moves relative to the main portion between a retracted position and an extended position.

19. The method of claim 18, including mounting a carrier plate of a length adjuster to selectively move with the forward portion of the seat cushion between the retracted position and the extended position.

20. The method of claim 19, including attaching the first portion of the trim attachment wire to the seat structure behind the carrier plate and providing the second portion of the trim attachment wire as an attachment point for the edge of trim material, and rotating the attachment point in response to movement of the carrier plate such that the attachment point moves to a low tension point during extension and the attachment point moves to a high tension point during retraction.
